(19) United States
(12) Patent Application Publication
(10) Pub. No.: US 2026/0368488 A1
(43) Pub. Date: Nov. 19, 2026

(54) MULTI-AGENT PROMPT REFINEMENT

(71) Applicant: Microsoft Technology Licensing, LLC, Redmond, WA (US)

(72) Inventors: Emmanuel ABOAH BOATENG, Atlanta, GA (US); Ehimwenma NOSAKHARE, Newton, MA (US); Sarah ZHANG, Seattle, WA (US)

(73) Assignee: Microsoft Technology Licensing, LLC, Redmond, WA (US)

(21) Appl. No.: 19/212,515

(22) Filed: May 19, 2025

(51) Int. Cl. G06N 3/0455

(52) U.S. Cl. CPC G06N 3/0455

(57) ABSTRACT

A computing system including one or more processing devices configured to obtain a prompt for use with a generative language model. The one or more processing devices execute machine learning (ML) agents that iteratively modify the prompt over a plurality of prompt refinement iterations. Each of the prompt refinement iterations includes, at a performance evaluation agent, computing a performance indicator value of the generative language model as prompted with the prompt. Each of the prompt refinement iterations further includes, at a security check agent, performing a security check on the generative language model as prompted with the prompt. Based at least on the performance indicator value and a security check result, each of the prompt refinement iterations further includes computing a multi-objective score, and, at a prompt generation agent, modifying the prompt based at least on the multi-objective score. The one or more processing devices output the modified prompt.

### BACKGROUND

Generative language models such as large language models (LLMs), small language models (SLMs), and large multimodal models (LMMs) have emerged as powerful tools for a multitude of natural language processing tasks such as question answering, summarization, sentiment analysis, and content generation. These machine learning (ML) models utilize prompts, which are textual instructions that guide the model toward a desired output. Consequently, a user may perform prompt engineering to elicit generative language model capabilities in specialized tasks.

### SUMMARY

According to one aspect of the present disclosure, a computing system is provided, including one or more processing devices configured to, at a multi-agent prompt refinement system, obtain a prompt for use with a generative language model. The one or more processing devices are further configured to execute a plurality of machine learning (ML) agents that iteratively modify the prompt over a plurality of prompt refinement iterations. Each of the prompt refinement iterations includes, at a performance evaluation agent included among the plurality of ML agents, computing a performance indicator value of the generative language model as prompted with the prompt. Each of the prompt refinement iterations further includes, at a security check agent included among the plurality of ML agents, performing a security check on the generative language model as prompted with the prompt. Based at least in part on the performance indicator value and a security check result of the security check, each of the prompt refinement iterations further includes computing a multi-objective score associated with the prompt. Each of the prompt refinement iterations further includes, at a prompt generation agent included among the plurality of ML agents, modifying the prompt based at least in part on the multi-objective score. The one or more processing devices are further configured to output the modified prompt computed in the plurality of prompt refinement iterations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system including one or more processing devices configured to execute a multi-agent prompt refinement system, according to one example embodiment.

FIG. 2 schematically shows the computing system when the one or more processing devices are configured to execute the orchestrator agent and an initialization module at the multi-agent prompt refinement system, according to the example of FIG. 1.

FIG. 3 schematically shows the computing system when the one or more processing devices are configured to execute a prompt refinement loop to perform a prompt refinement iteration, according to the example of FIG. 1.

FIG. 4 schematically shows the computing system in an example in which a prompt critic agent is executed to update a performance term weight and a security term weight of a multi-objective function, according to the example of FIG. 3.

FIG. 5 schematically shows the computing system in an example in which the one or more processing devices are further configured to perform a model migration check during the prompt refinement loop, according to the example of FIG. 3.

FIG. 6A shows a flowchart of a method for use with a computing system to implement a multi-agent prompt refinement system, according to the example of FIG. 1.

FIGS. 6B-6F show additional steps of the method of FIG. 6A that may be performed in some examples.

FIG. 7 shows a schematic view of an example computing environment in which the computing system of FIG. 1 may be instantiated.

### DETAILED DESCRIPTION

Users of ML systems that include generative language models typically perform prompt engineering manually, relying on trial-and-error approaches that can be time-consuming and inconsistent. In addition, the prompts obtained through manual prompt engineering are typically model-specific. If the user switches to using a different generative language model, or if additional training such as finetuning is performed at the generative language model, the user may have to repeat the process of prompt engineering to elicit the desired capabilities.

In prompt engineering scenarios such as development of a system prompt (a prompt that is used to initialize interactions between a generative language model and a user of a chat interface), safety and security considerations sometimes arise. For example, a developer may intend to obtain a system prompt that is robust to adversarial inputs and that avoids data leakage and model jailbreaks. Safety evaluation is typically performed in a red-teaming phase after a developer has written the system prompt. However, the process of iteratively rewriting and red-teaming a system prompt may be slow. Red-teaming refers to a trial-and-error process of determining whether a model produces output that violates a policy, in response to certain inputs, and is used to tailor model behaviors to meet tenant and platform policy goals. Development of a system prompt that meets safety and security standards may accordingly become a bottleneck in the process of developing generative language models and applications thereof.

Techniques for programmatic prompt refinement have been developed, such as reinforcement-learning-based techniques and evolutionary search systems. These prior techniques iteratively modify a prompt to compute a refined prompt that approximately minimizes or maximizes an objective function. While some frameworks allow single or limited multi-objective optimization, they often address only performance metrics. Many existing prompt refinement frameworks-whether reinforcement-learning-based, evolutionary, or heuristic-driven-treat performance accuracy or related metrics (e.g., perplexity, BLEU score) as the sole objective.

Previous prompt refinement techniques do not account for model migration, i.e., transferring or adapting prompts from an older (source) model to a newer (destination) model without losing model functionality or stylistic features of model outputs. For example, prompt migration may be performed to switch to an ML model that has more advanced capabilities or lower inferencing costs. Existing prompt refinement methods lack built-in mechanisms for preserving intended behaviors and performance when transitioning from one model (the source) to another (the destination). As a result, specialized behaviors and/or stylistic cues cultivated in the source model are lost. Attempting to manually retrofit prompts or replicate results on the new model is a process rife with inefficiencies and potential performance regressions. Without a structured approach to backward compatibility, organizations can face inconsistent user experiences and higher costs in revalidating system outputs.

Prior prompt refinement techniques also do not incorporate safety and security checks into the prompt refinement workflow. Security measures are instead often implemented, for example, using post-processing filters or simple blacklists of disallowed terms. Such static approaches may fail to address the dynamic nature of security threats, including adversarial prompts that evolve over time or zero-day vulnerabilities arising from novel hacking techniques. Moreover, these security filters do not directly inform or influence the prompt optimization pipeline. Post-processing filters react to model outputs generated after prompt refinement and may therefore fail to prevent some forms of undesirable behavior. This lack of continuous feedback leads to iterative blind spots where potential risks are neither proactively detected nor remedied during prompt generation.

Existing prompt refinement techniques also rely on static processing pipelines. To change the processing pipeline with which a modified prompt is generated, a developer may have to perform time-consuming rewrites of the prompt refinement workflow. Existing prompt refinement pipelines are therefore difficult to adapt for use with different ML models, or to incorporate newly developed performance benchmarks or safety techniques. Such static pipelines are also unequipped to test for newly emergent safety risks that may arise as model capabilities advance.

In order to address the above challenges, the present disclosure introduces a collaborative, multi-agent framework for prompt refinement. Rather than relying on a single monolithic system or a simple filter-based optimization approach, the multi-agent prompt refinement system presented herein orchestrates multiple specialized ML agents, each of which handles a specific dimension of the prompt engineering life cycle (e.g., prompt generation, synthetic data generation, security checks, and performance evaluation). The multi-agent prompt refinement system integrates these ML agents using an orchestrator agent.

The multi-agent prompt refinement system updates the prompt according to a weighted multi-objective score function. This multi-objective score function includes terms related to both a performance indicator and a security check. A term that specifies an objective related to model migration may also be included in the weighted multi-objective score function. The multi-agent prompt refinement system therefore integrates safety/security checks (and in some examples, model migration checks) into the prompt refinement loop as first-class objectives rather than relying on separate phases to test safety/security and model migration properties.

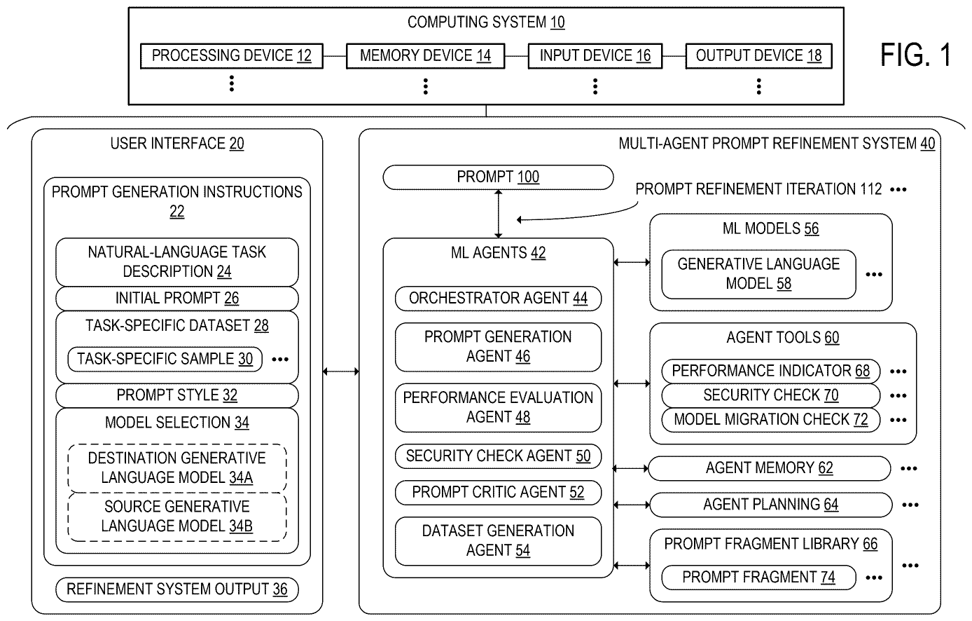

FIG. 1 schematically shows an example computing system 10 including one or more processing devices 12 configured to execute a multi-agent prompt refinement system 40. The one or more processing devices 12 may, for example, include one or more central processing units (CPUs), graphics processing units (GPUs), neural processing units (NPUs), and/or other types of hardware accelerators. The computing system 10 further includes one or more memory devices 14, which may, for example, include one or more volatile memory devices and one or more non-volatile storage devices. The computing system 10 further includes one or more input devices 16 and one or more output devices 18. In some examples, the computing system 10 may be instantiated in a single physical computing device, whereas in other examples, the functionality of the one or more processing devices 12, memory devices 14, input devices 16, and/or output devices 18 may be distributed across a plurality of physical computing devices.

In addition to the multi-agent prompt refinement system 40, the one or more processing devices 12 are further configured to execute a user interface 20 via which the one or more processing devices 12 are configured to receive user inputs to the multi-agent prompt refinement system 40 and present one or more refinement system outputs 36 to the user. For example, the user interface 20 may be a graphical user interface (GUI). Additionally or alternatively, the user interface 20 may have audio interface capabilities.

At the multi-agent prompt refinement system 40, the one or more processing devices 12 are configured to obtain a prompt 100 for use with a generative language model 58. For example, the one or more processing devices 12 may be configured to obtain the prompt 100 at least in part by receiving prompt generation instructions 22 at the user interface 20. The prompt generation instructions 22 may include a natural-language task description 24 and/or an initial prompt 26. In examples in which the prompt generation instructions 22 include the natural-language task description 24, the one or more processing devices 12 may be configured to preprocess the natural-language task description 24 at least in part at a generative language model 58 to obtain the prompt 100. In examples in which the prompt generation instructions 22 include an initial prompt 26, that initial prompt 26 may be used as the prompt 100.

In the following discussion, it is understood that the prompt 100 may be a portion of the data included in the context window of an ML model 56 in some examples, rather than the entire context the ML model 56 receives as an input. For example, the prompt 100 may be a system prompt that is used to initialize a plurality of conversational turns exchanged between a user and an ML model 56 at a chat interface. Accordingly, when the prompt 100 is used as a system prompt of the ML model 56, the ML model 56 is configured to compute inferencing outputs from a context that includes both the system prompt and one or more prior conversational turns, which may include one or more user inputs and may further include one or more prior outputs generated at the ML model 56.

In some examples, the prompt generation instructions 22 further include a task-specific dataset 28, which includes a plurality of task-specific samples 30. The task-specific samples 30 may be input-output pairs that provide examples of a task the user intends for the generative language model 58 to perform. During modification of the prompt 100, as discussed below, the task-specific samples 30 may be used to perform prompt evaluation, validation, and testing.

The prompt generation instructions 22 may further include a prompt style 32. The prompt style 32 may indicate whether the one or more processing devices 12 are configured to compute the prompt 100 as a chain-of-thought (CoT) prompt, a tree-of-thought (ToT) prompt, or a prompt that does not have either a CoT structure or a ToT structure.

The prompt generation instructions 22 further include a model selection 34 that indicates an ML model 56 at which the prompt 100 is used as an input. In the examples provided below, the ML model 56 indicated in the model selection 34 is a generative language model 58. However, in other examples, the prompt 100 may instead be used as an input to an ML model 56 that receives a text input and has some other output modality. For example, the prompt 100 may be a prompt to a text-to-image (T2I) model.

In examples in which model migration is performed, the model selection 34 may indicate a destination generative language model 34A and a source generative language model 34B. The destination generative language model 34A is the ML model 56 to which prompt migration is performed at the multi-agent prompt refinement system 40, and the source generative language model 34B is the model from which the prompt 100 is migrated.

Subsequently to receiving the prompt generation instructions 22, the one or more processing devices 12 are further configured to execute a plurality of ML agents 42 that iteratively modify the prompt 100 over a plurality of prompt refinement iterations 112. In the example of FIG. 1, the set of ML agents 42 included in the multi-agent prompt refinement system 40 includes an orchestrator agent 44, a prompt generation agent 46, a performance evaluation agent 48, a security check agent 50, a prompt critic agent 52, and a dataset generation agent 54. The computing processes performed at these ML agents 42 are discussed in further detail below.

Each of the ML agents 42 included in the multi-agent prompt refinement system 40 is configured to perform calls to one or more ML models 56. For example, the one or more ML models 56 may include one or more generative language models 58. Other types of ML models 56, such as a classifier model or and embedding model, may also be executed at the one or more ML agents 42. In some examples, an ML agent 42 may be configured to perform calls to a domain-specialized ML model, which may be a generative language model 58 that has been finetuned with a domain-specific finetuning dataset. For example, an ML agent 42 may be configured to perform calls to a generative language model 58 that has been finetuned to answer questions related to cybersecurity or questions related to legal compliance.

In addition to the one or more ML models 56, an ML agent 42 may be further configured to perform calls to one or more agent tools 60. The one or more agent tools 60 each include code that may be invoked by the ML agent 42 to perform tasks such as interacting with an external application program or testing outputs of an ML model 56 against a benchmark. As shown in the example of FIG. 1, the set of agent tools 60 executed at the multi-agent prompt refinement system 40 may include one or more performance indicators 68 utilized at the performance evaluation agent 48, one or more security checks 70 performed at the security check agent 50, and one or more model migration checks 72 performed at the performance evaluation agent 48 and/or the security check agent 50.

The set of agent tools 60 included in the multi-agent prompt refinement system 40 is configured to be extensible. This extensibility may allow a developer to provide a newly introduced performance indicator 68 or security check 70 to the one or more ML agents 42. As additional performance benchmarks and alignment techniques are developed, those benchmarks and techniques may accordingly be incorporated into the prompt refinement workflow without the developer having to spend large amounts of time on workflow restructuring. By extending the set of agent tools 60 available to the ML agents 42, performance benchmarks and alignment techniques may also be tested in a prompt refinement setting.

The ML agents 42 are further configured to utilize agent memory 62. The agent memory 62 associated with an ML agent 42 may store prior inputs and outputs of the ML agent 42, and/or a compressed version of those prior inputs and outputs. In the example of FIG. 1, the ML agents 42 are further configured to perform agent planning 64 to compute a plan of one or more subsequent actions. For example, the agent planning 64 may be performed using a scratchpad and may include generating a CoT or ToT at a generative language model 58.

In the example of FIG. 1, the multi-agent prompt refinement system 40 includes one or more prompt fragment libraries 66 associated with the ML agents 42. A prompt fragment library 66 includes a plurality of prompt fragments 74 that may be included in the prompt of a generative language model 58 when an ML agent 42 calls that generative language model 58. For example, the prompt fragments 74 may be portions of prompts that have been generated during prior instances of iterative prompt refinement in order to reliably elicit specific behaviors from one or more of the generative language models 58. In some examples, one or more of the prompt fragments 74 may also be incorporated into the prompt 100 during prompt refinement.

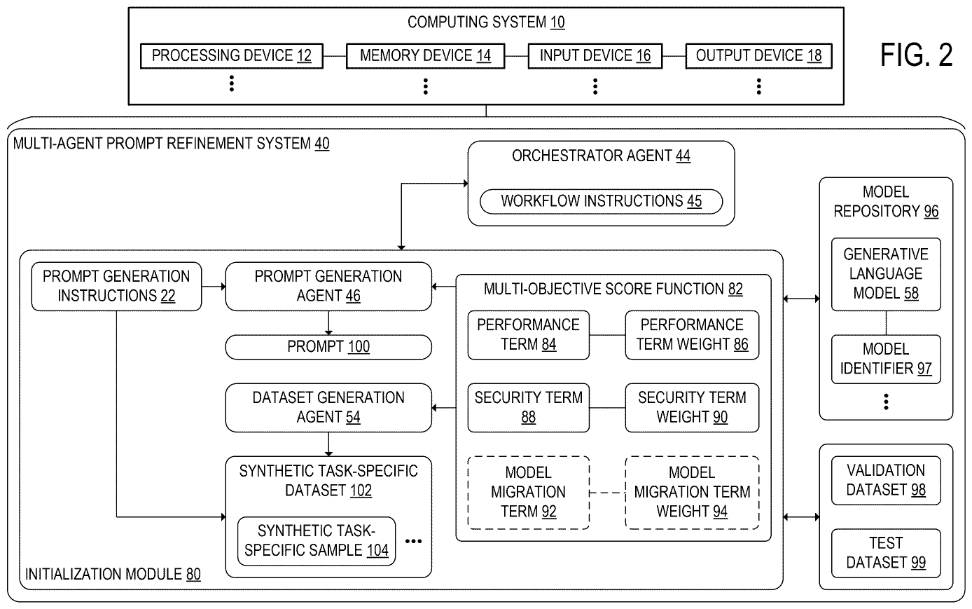

FIG. 2 schematically shows the computing system 10 when the one or more processing devices 12 are configured to execute the orchestrator agent 44 and an initialization module 80 at the multi-agent prompt refinement system 40. At the orchestrator agent 44, the one or more processing devices 12 are further configured to compute workflow instructions 45 associated with the ML agents 42. The one or more processing devices 12 are further configured to execute the plurality of ML agents 42 with a workflow structure specified in the workflow instructions 45. The orchestrator agent 44 may, for example, be configured to compute a pipeline graph of the respective inputs and outputs of the other ML agents 42 included in the multi-agent prompt refinement system 40. By executing the workflow instructions 45, the one or more processing devices 12 may be configured to selectively invoke the ML agents 42 with respective input sources and output destinations selected at the orchestrator agent 44.

At the initialization module 80, the one or more processing devices 12 are further configured to input the prompt generation instructions 22 into the prompt generation agent 46, at which the one or more processing devices 12 are further configured to compute an initial version of the prompt 100. In examples in which the prompt generation instructions 22 include an initial prompt 26, the prompt generation agent 46 may be configured to set the prompt 100 to that initial prompt 26.

At the initialization module 80, the one or more processing devices 12 may be further configured to obtain data that is later used in the plurality of prompt refinement iterations 112. The one or more processing devices 12 may, for example, be configured to retrieve respective model identifiers 97 of the one or more generative language models 58 specified in the model selection 34. Other data associated with the one or more generative language models 58, such as an indication of an application-programming interface (API) associated with a generative language model 58, may also be received at the initialization module 80.

The one or more processing devices 12 are further configured to retrieve an initial version of a multi-objective score function 82. The multi-objective score function 82, as shown in the example of FIG. 2, includes a performance term 84, a security term 88, and a model migration term 92. These terms respectively have a performance term weight 86, a security term weight 90, and a model migration term weight 94. As discussed in further detail below, the performance term weight 86, the security term weight 90, and the model migration term weight 94 may be dynamically updated over the course of prompt refinement. The one or more processing devices 12 are configured to set the initial values of these term weights at the initialization module 80 in the example of FIG. 2. The performance term weight 86, the security term weight 90, and (when included) the model migration term weight 94 may be normalized to sum to one.

In examples in which the prompt generation instructions 22 include a task-specific dataset 28, the one or more processing devices 12 may be further configured to split that task-specific dataset 28 into a validation dataset 98 and a test dataset 99 that each include a respective plurality of the task-specific samples 30. In some examples, synthetic data generation may additionally or alternatively be performed at the initialization module 80. In such examples, at the dataset generation agent 54, the one or more processing devices 12 are further configured to compute a synthetic task-specific dataset 102 including a plurality of synthetic task-specific samples 104. These synthetic task-specific samples 104 are computed based at least in part on the prompt generation instructions 22. For example, when the prompt generation instructions 22 include a natural-language task description 24, the one or more processing devices 12 may be configured to execute the dataset generation agent 54 to compute synthetic examples of the task specified in the natural-language task description 24. In examples in which the prompt generation instructions 22 include a task-specific dataset 28, the dataset generation agent 54 may be executed to augment the task-specific dataset 28 with the synthetic task-specific samples 104. The synthetic task-specific dataset 102 may also be divided into a validation dataset 98 and a test dataset 99 at the initialization module 80. In some examples, the validation dataset 98 and the test dataset 99 may each include a mix of the task-specific samples 30 and the synthetic task-specific samples 104.

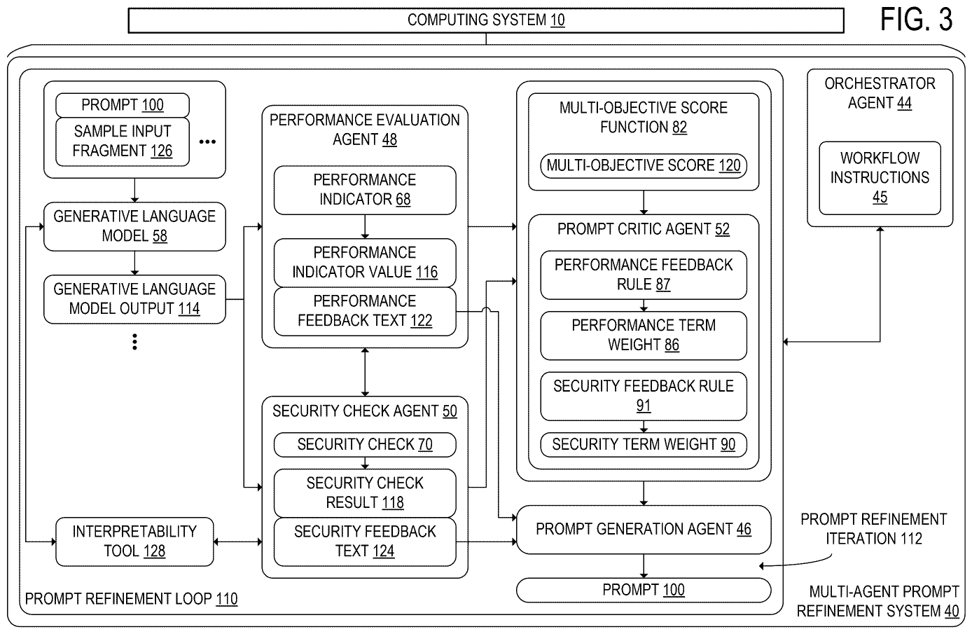

FIG. 3 schematically shows the computing system 10 when the one or more processing devices 12 are configured to execute a prompt refinement loop 110 to perform a prompt refinement iteration 112. In the prompt refinement iteration 112, the one or more processing devices 12 are configured to process the prompt 100 at the selected generative language model 58 to compute a generative language model output 114. The one or more processing devices 12 are further configured to input the generative language model output 114 into the performance evaluation agent 48 and the security check agent 50. In some examples, the one or more processing devices 12 are configured to compute a plurality of different generative language model outputs 114 using, as inputs to the generative language model 58, the prompt 100 together with different respective sample input fragments 126. Each of the sample input fragments 126 may be obtained from the task-specific dataset 28 or the synthetic task-specific dataset 102.

At the performance evaluation agent 48, the one or more processing devices 12 are configured to compute a performance indicator value 116 of the generative language model 58 as prompted with the prompt 100. The performance indicator value 116 is computed using a performance indicator 68, as evaluated for one or more of the generative language model outputs 114. In examples in which the one or more processing devices 12 are configured to compute respective generative language model outputs 114 using different respective sample input fragments 126, the one or more processing devices 12 may be configured to aggregate the performance indicator value 116 across the generative language model outputs 114. Accordingly, the one or more processing devices 12 may be configured to compute the performance indicator value 116 based at least in part on the task-specific samples 30 and/or the synthetic task-specific samples 104.

The generative language model outputs 114 may be tested on a plurality of different performance indicators 68 at the performance evaluation agent 48 in some examples. Thus, the performance of the generative language model 58 as prompted with the prompt 100 may be benchmarked using a plurality of different benchmarks, which may be aggregated into a combined performance indicator value 116 or left as separate performance indicator values 116. In some examples, the performance indicator 68 may be computed using one or more properties of the generative language model 58 other than those of the generative language model output 114. For example, a performance indicator 68 may be computed based at least in part on an inferencing latency of the generative language model 58.

At the security check agent 50, the one or more processing devices 12 are further configured to perform a security check 70 on the generative language model 58 as prompted with the prompt 100. The one or more processing devices 12 are accordingly configured to compute a security check result 118 of the security check 70. The security check result 118 may take the form of a numerical score. As discussed above with reference to the performance evaluation agent 48, the security check 70 may be performed on a plurality of generative language model outputs 114 computed using the prompt 100 and different respective sample input fragments 126. Accordingly, the one or more processing devices 12 may be configured to perform the security check 70 based at least in part on the task-specific samples 30 and/or the synthetic task-specific samples 104. The security check agent 50 may test the prompt 100 for safety and/or security risks such as susceptibility to jailbreaks, confidential data leaks, generation of harmful outputs, hallucinations, deception of users, generation of insecure code, and/or other types of risks or unwanted behaviors. The security check agent 50 may be configured to perform a plurality of different security checks 70 in some examples.

In some examples, the security check agent 50 may utilize other inputs in addition to the generative language model outputs 114. For example, the security check agent 50 may be configured to invoke an interpretability tool 128 that probes one or more internal properties of the generative language model 58, such as one or more activations. Interpretability results computed at the interpretability tool 128 may be used as additional inputs to the security check agent 50, for example, when testing for behaviors such as hallucinations and deception.

In some examples, the security check agent 50 and the performance evaluation agent 48 may be executed in sequence. For example, the security check may be performed on the prompt 100 prior to computation of the performance indicator value 116. In such examples, the one or more processing devices 12 may be configured to skip performance evaluation at the performance evaluation agent 48 and instead proceed to modification of the prompt 100 in examples in which the prompt 100 fails the security check 70. In such examples, the one or more processing devices 12 may be configured to compute a security score associated with the prompt 100, and to skip performance evaluation if the prompt 100 is below a security score threshold.

Alternatively, the security check agent 50 and the performance evaluation agent 48 may be executed in parallel. In such examples, security check agent 50 and the performance evaluation agent 48 may exchange security-related data and performance-related data when computing the performance indicator value 116 and performing the security check 70. Communication between the security check agent 50 and the performance evaluation agent 48 may be scheduled by the orchestrator agent 44. As an example, the security check agent 50 may detect that the generative language model 58 received an unusually low performance indicator value 116 for a specific performance indicator 68. The security check agent 50 may be further configured to flag that low performance indicator value 116 as a potential instance of sandbagging, a type of deceptive behavior in which an ML model 56 conceals specific capabilities (e.g., harmful or dangerous capabilities) by selectively underperforming on evaluations of those capabilities. Including the security check agent 50 in the prompt refinement loop 110 and allowing the security check agent 50 to communicate with the performance evaluation agent 48 may therefore allow the one or more processing devices 12 to programmatically detect sandbagging during prompt refinement rather than requiring a separate red-teaming phase.

Based at least in part on the performance indicator value 116 and the security check result 118, the one or more processing devices 12 are further configured to compute a multi-objective score 120 associated with the prompt 100 at the multi-objective score function 82. The multi-objective score function 82, as discussed above, includes a performance term 84 that has a performance term weight 86 and a security term 88 that has a security term weight 90. The one or more processing devices 12 are further configured to input the multi-objective score 120 into the prompt generation agent 46, at which the one or more processing devices 12 are configured to modify the prompt 100 based at least in part on the multi-objective score 120. The modification to the prompt 100 may be performed at least in part at a generative language model 58, using the prompt 100, the performance indicator value 116, and the security check result 118 as input. Over the plurality of prompt refinement iterations 112, the one or more processing devices 12 may be configured to compute a prompt 100 that approximately maximizes the multi-objective score 120.

In the example of FIG. 3, during each of the prompt refinement iterations 112, the one or more processing devices 12 are further configured to compute performance feedback text 122 at the performance evaluation agent 48. In addition, the one or more processing devices 12 are further configured to compute security feedback text 124 at the security check agent 50. The performance feedback text 122 and the security feedback text 124 respectively provide qualitative feedback related to the performance and safety/security of the generative language model 58 as prompted with the prompt 100, in addition to the quantitative feedback provided in the performance indicator value 116 and the security check result 118. The prompt generation agent 46 may be configured to utilize the performance feedback text 122 and the security feedback text 124 as additional inputs to the generative language model 58 when updating the prompt 100.

The one or more processing devices 12 are further configured to execute a prompt critic agent 52 in the example of FIG. 3. At the prompt critic agent 52, the one or more processing devices 12 are further configured to update the performance term weight 86 and the security term weight 90 based at least in part on the performance indicator value 116 and the security check result 118. In examples in which performance feedback text 122 is computed at the performance evaluation agent 48 and security feedback text 124 is computed at the security check agent 50, the one or more processing devices 12 may be further configured to update the performance term weight 86 and the security term weight 90 at the prompt critic agent 52 based at least in part on the performance feedback text 122 and the security feedback text 124. At each of the prompt refinement iterations 112, in order to maintain a consistent scale for the multi-objective score function 82, the one or more processing devices 12 may be configured to normalize the term weights to sum to one.

In some examples, at the prompt critic agent 52, the one or more processing devices 12 may be further configured to compute a performance feedback rule 87 and a security feedback rule 91 based at least in part on the performance feedback text 122 and the security feedback text 124, respectively. The one or more processing devices 12 may be further configured to compute the performance term weight 86 and the security term weight 90 according to the performance feedback rule 87 and the security feedback rule 91. The performance feedback rule 87 and the security feedback rule 91 may be learned policies computed at a reinforcement learning model included in the prompt critic agent 52. As another example, the one or more processing devices 12 may be configured to compute the performance feedback rule 87 and the security feedback rule 91 at least in part by filling fillable fields of corresponding templates using a generative language model 58 that receives the performance feedback text 122 and the security feedback text 124 as inputs. The one or more processing devices 12 may be configured to cache the performance feedback rule 87 and/or the security feedback rule 91 for later use in prompt refinement at the generative language model 58 or another generative language model.

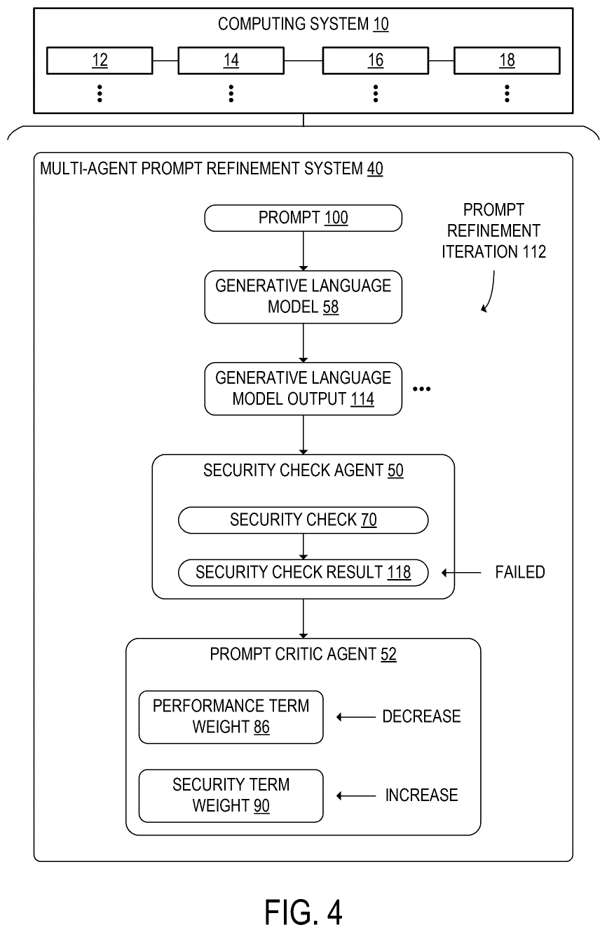

FIG. 4 schematically shows the computing system 10 in an example in which the prompt critic agent 52 is executed to update the performance term weight 86 and the security term weight 90. In the example of FIG. 4, the one or more processing devices 12 are configured to determine, at the security check agent 50, that the generative language model 58 as prompted with the prompt 100 fails the security check 70. At the prompt critic agent 52, in response to determining that the generative language model 58 fails the security check 70, the one or more processing devices 12 are further configured to increase the security term weight 90 used in a subsequent prompt refinement iteration 112 of the plurality of prompt refinement iterations 112. Accordingly, in response to detecting a security check failure, the one or more processing devices 12 are configured to place increased emphasis on the security check result 118 in the multi-objective score function 82.

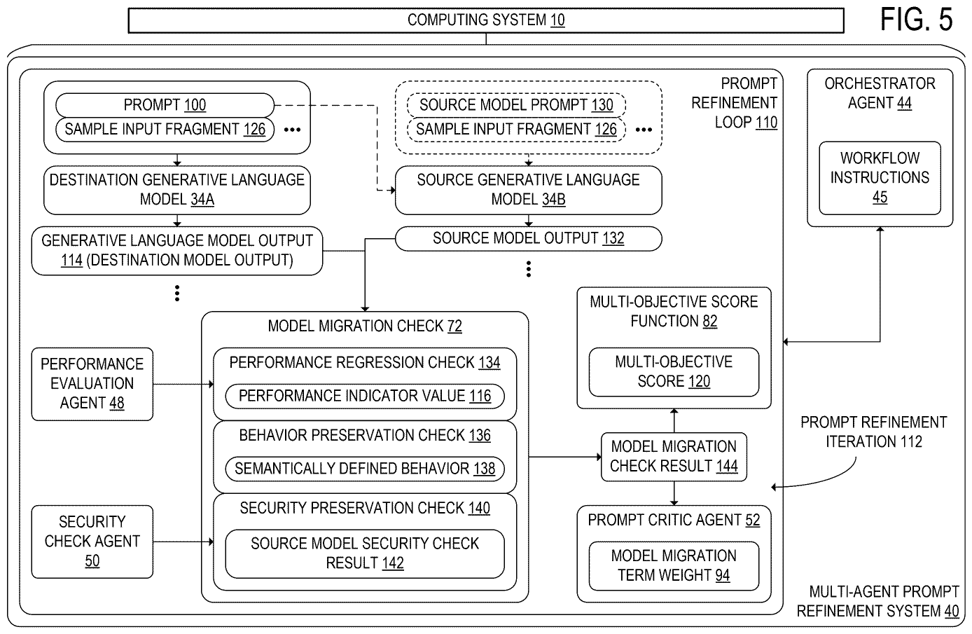

FIG. 5 schematically shows the computing system 10 in an example in which the one or more processing devices 12 are further configured to perform a model migration check 72 during the prompt refinement loop 110. In such examples, the generative language model 58 for which the prompt 100 is iteratively computed is a destination generative language model 34A specified in the model selection 34. In each of the prompt refinement iterations 112, the one or more processing devices 12 are further configured to perform a model migration check 72 on the destination generative language model 34A as prompted with the prompt 100. The model migration check 72 compares one or more destination model outputs 114 of the destination generative language model 34A, as prompted with the prompt 100, to one or more source model outputs 132 of a source generative language model 34B.

The model migration check 72 may be performed over a sample including a plurality of different destination model outputs 114 and corresponding source model outputs 132. In some examples, to compute the one or more destination model output 114 and the one or more source model output 132, the same prompt 100 is used as an input to both the destination generative language model 34A and the source generative language model 34B when the model migration check 72 is performed. In other examples, a source model prompt 130 may be used as an input to the source generative language model 34B during the model migration check 72. The source model prompt 130 may be a prompt that was previously computed via prompt refinement for the source generative language model 34B, and that approximately maximized the multi-objective score function 82 during that prompt refinement. The inputs to the destination generative language model 34A and the source generative language model 34B may further include one or more sample input fragments 126. The model migration check 72 may be performed for a plurality of different sample input fragments 126 obtained from the task-specific dataset 28 and/or the synthetic task-specific dataset 102.

The model migration check 72 may be performed at least in part at the performance evaluation agent 48. In such examples, the model migration check 72 may be a performance regression check 134 in which the one or more processing devices 12 are configured to determine whether the one or more destination model outputs 114 have a lower performance indicator value 116 than the one or more source model output 132. Accordingly, the model migration check 72 may be performed in order to avoid degrading performance of the destination generative language model 34A on the performance indicator 68 relative to the source generative language model 34B.

In some examples, the model migration check 72 may be a behavior preservation check 136 that includes determining whether the destination generative language model 34A preserves one or more semantically defined behaviors 138 of the source generative language model 34B. The one or more semantically defined behaviors 138 may, for example, be one or more stylistic features of the generative language model outputs 114. The one or more semantically defined behaviors 138 may be specified in the natural-language task description 24 included in the prompt generation instructions 22. In order to determine whether the destination generative language model 34A preserves the one or more semantically defined behaviors 138, the one or more processing devices 12 may be configured to compute an embedding similarity value between the one or more destination model outputs 114 and the one or more source model outputs 132. Additionally or alternatively, a generative language model 58 may be used to classify the one or more destination model outputs 114 and the one or more source model outputs 132 according to whether the one or more semantically defined behaviors 138 are preserved. The behavior preservation check 136 may, for example, be performed in order to preserve performance on a task that does not have a predetermined benchmark usable as ground truth.

In some examples, the model migration check 72 may be a security preservation check 140 in which the one or more processing devices 12 are configured to determine whether the destination generative language model 34A preserves one or more source model security check results 142 computed for the source generative language model 34B. The one or more processing devices 12 may accordingly be configured to check whether the destination generative language model 34A, as prompted with the prompt 100, exhibits one or more safety/security properties of the source generative language model 34B. For example, a jailbreak rate or hallucination rate of the destination generative language model 34A may be compared to a rate computed for the source generative language model 34B.

The one or more processing devices 12 are further configured to compute the multi-objective score 120 based at least in part on a model migration check result 144 of the model migration check 72. In some examples, as discussed above with reference to FIG. 2, the multi-objective score function 82 may include a model migration term 92 that has a model migration term weight 94. The model migration check result 144 may accordingly be incorporated into the iterative refinement of the prompt 100. In addition, at the prompt critic agent 52, the one or more processing devices 12 may be further configured to modify the model migration term weight 94. For example, the one or more processing devices 12 may be configured to increase the model migration term weight 94 in a subsequent prompt refinement iteration 112 in response to determining that the destination model output 114 fails the model migration check 72.

The orchestrator agent 44 may be configured to instruct the multi-agent model refinement system 40 to execute the prompt refinement loop 110 until one or more predefine conditions on the performance, safety/security, and/or model migration properties of the prompt 100 have been met, as indicated in the performance indicator 68, security check 70, and/or model migration check 72. Using the test dataset 99, the one or more processing devices 12 may be further configured to test the prompt 100 after the plurality of prompt refinement iterations 112 have been performed.

Subsequently to performing the plurality of prompt refinement iterations 112, the one or more processing devices 12 are further configured to output the modified prompt 100 computed in the plurality of prompt refinement iterations 112. The prompt 100 following iterative refinement may be output to the user interface 20 as a refinement system output 36, as shown in the example of FIG. 1. The refinement system output 36 may further include one or more performance indicator values 116, security check results 118, and/or model migration check results 144. A modification history of the prompt 100 may also be included in the refinement system output 36.

A formal description of prompt refinement is provided below. For a task T, a dataset

$$D = {\{ ( {Q}_{i} , {A}_{i} ) \}}_{i = 1}^{N}$$

is provided. The dataset D is a set of N input-output pairs in which Qᵢ represents the input query and Aᵢ represents the ground truth answer or label. The generative language model is represented as [symbol] . For a given prompt template p concatenated with an input query Qᵢ, the generative language model produces an output [symbol] (pᵢ, Qᵢ).

The prompt refinement loop 110 is executed to approximate a prompt p* that maximizes a score function on the task T. The output prompt p* of single-objective maximization is given by:

$${p}^{*} = arg {max}_{p ∈ χ} {𝔼}_{( Q , A ) \sim D} [ K ( p , ℒ ) ]$$

In the above equation, x is the space of possible prompts and K(p, [symbol] ) is the performance metric.

Single-objective maximization is extended in the following example to two-objective maximization in which a security metric S(p, [symbol] ) is used alongside the performance metric K(p, [symbol] ). When both of these metrics are included, the output prompt may be computed as follows:

$${p}_{sec}^{*} = arg {max}_{p ∈ χ} {𝔼}_{( Q , A ) \sim D} [ {w}_{1} ( α , β ) K ( p , ℒ ) + {w}_{2} ( α , β ) S ( p , ℒ ) ]$$

In the above equation, w₁(α, β) and w₂(α, β) are dynamic weights of the performance term and the security term. α and β are the performance feedback rule and the security feedback rule that are respectively computed from performance-related feedback and safety/security-related feedback.

In the above equation, the dynamic weights may be normalized such that w₁(α,β)+w₂(α, β)=1. Although w₁ is the dynamic weight associated with the performance indicator and w₂ is the weight associated with the security check, these weights may be computed as functions of both α and β in order to allow the prompt critic agent 52 to incorporate feedback from both the performance evaluation agent 48 and the security check agent 50 when computing each of the weights.

In some examples, a hard constraint on the security metric S(p, [symbol] ) may

$${p}_{sec}^{*} .$$

as S(p)≥γ, such that a prompt with a security score below a threshold γ is discarded regardless of its performance indicator value. An overall score threshold ζ may additionally or alternatively be used. In examples in which the security metric constraint and the overall score constraint are placed on the prompt refinement, the equation for the output prompt may be given as follows:

$${p}_{sec}^{*} = arg {max}_{p ∈ χ} {𝔼}_{( Q , A ) \sim D} [ {w}_{1} ( α , β ) K ( p , ℒ ) + {w}_{2} ( α , β ) S ( p , ℒ ) ]$$

$$Subject to : S ( p , ℒ ) \geq γ and Overall score \geq ζ$$

In examples in which a model migration check 72 is performed, that model migration check 72 may be integrated into the prompt refinement loop 110 using a constraint-based approach. In the constraint-based approach, the performance of the source generative language model 34B on a validation dataset 98 or a test dataset 99 may be used as a bound on the performance of the destination generative language model 34A. The performance indicator value 116 of the source generative language model [symbol] on a prompt p is given as K_{source}(p). This source model value K_{source}(p) may, for example, be accuracy on a validation dataset or test dataset, or may alternatively be a style similarity score or style alignment score.

The constraint-based model migration check may utilize a soft constraint in some examples. In such examples, K_{source}(p) is computed during initialization of the prompt p before entering the prompt refinement loop 110. This value of K_{source}(p) is then compared to the performance indicator values of the prompt p. The output prompt may therefore be computed as follows:

$${p}_{sec}^{*} = arg {max}_{p ∈ χ} {𝔼}_{( Q , A ) \sim D} [ {w}_{1} ( α , β ) K ( p , ℒ ) + {w}_{2} ( α , β ) S ( p , ℒ ) ]$$

$$Subject to : S ( p , ℒ ) \geq γ and Overall score ( {p}_{sec}^{*} ) \geq ζ and K ( p , {ℒ}_{new} ) \geq {λ}_{fixed}$$

In the above equation, [symbol] is the destination generative language model, and λ_{fixed}=K_{source}(p_{baseline}, [symbol] ) is a lower bound on the performance indicator value obtained by the destination generative language model. [symbol] is the source generative language model 34B, and p_{baseline} is the source model prompt 130. Thus, the soft constraint may be used to perform the performance regression check 134.

In other examples, a hard constraint may be used in the performance regression check 134. In such examples, at each prompt refinement iteration 112, the one or more processing devices 12 are further configured to compute the performance score K of the source model [symbol] using the prompt p computed during that prompt refinement iteration 112. The one or more processing devices 12 are further configured to compare the performance of each prompt p on the destination generative language model [symbol] new to the performance of that prompt on the source generative language model [symbol] . The output prompt may accordingly be computed as follows when a hard constraint is used:

$${p}_{sec}^{*} = arg {max}_{p ∈ χ} {𝔼}_{( Q , A ) \sim D} [ {w}_{1} ( α , β ) K ( p , ℒ ) + {w}_{2} ( α , β ) S ( p , ℒ ) ]$$

$$Subject to : S ( p , ℒ ) \geq γ and Overall score ( {p}_{sec}^{*} ) \geq ζ and K ( p , {ℒ}_{new} ) \geq {λ}_{dynamic}$$

In the above equation, λ_{dynamic} is the performance indicator value K of the source generative language model [symbol] source on the prompt computed at that iteration.

In the following examples, the multi-objective score function 82 includes a model migration term 92. For example, the model migration term 92 may be implemented according to the following equation for the output prompt:

$${p}_{sec}^{*} = arg {max}_{p ∈ χ} {𝔼}_{( Q , A ) \sim D} [ \text{} {w}_{1} ( α , β ) {K}_{new} ( p , {ℒ}_{new} ) + {w}_{2} {K}_{source} ( p , {ℒ}_{source} ) + {w}_{3} ( α , β ) S ( p , {ℒ}_{new} ) ]$$

$$Subject to : S ( p , ℒ ) \geq γ and Overall score ( {p}_{sec}^{*} ) \geq ζ$$

In the above equation, K_{new}(p, [symbol] ) is the performance score of the prompt p on the destination generative language model [symbol] , and K_{source}(p, [symbol] ) is the performance score of the prompt p on the source generative language model [symbol] . w₂ is the model migration term weight 94. The prompt critic agent 52 may be configured to adjust w₂ based at least in part on α and β.

In examples in which the one or more processing devices 12 are configured to both maintain performance and stylistic consistency from the source generative language model £source to the destination generative language model [symbol] , the output prompt may be computed according to the following equation:

$${p}_{sec}^{*} = arg {max}_{p ∈ χ} {𝔼}_{( Q , A ) \sim D} [ {w}_{1} ( α , β ) {K}_{new} ( p , {ℒ}_{new} ) + {w}_{2} [ {K}_{source}^{( accuracy )} ( p , {ℒ}_{source} ) + \text{} Align ( {out}_{source} ( p ) , {out}_{new} ( p ) ] + {w}_{3} ( α , β ) S ( p , {ℒ}_{new} ) ]$$

$$Subject to : S ( p , ℒ ) \geq γ and Overall score ( {p}_{sec}^{*} ) \geq ζ$$

In the above equation, outsource (p) and out_{new}(p) are text outputs of the source generative language model [symbol] and the destination generative language model [symbol] , respectively. Align(⋅) is a semantic similarity metric, such as cosine similarity between embedding vectors, or a similarity score computed at a generative language model.

$${K}_{source}^{( accuracy )} ( p , {L}_{source} )$$

is the accuracy of the source generative language model on a validation dataset. Accordingly, in this example, the model migration term 92 includes a term that measures performance at the source generative language model as well as a term that measures alignment between source and destination model outputs.

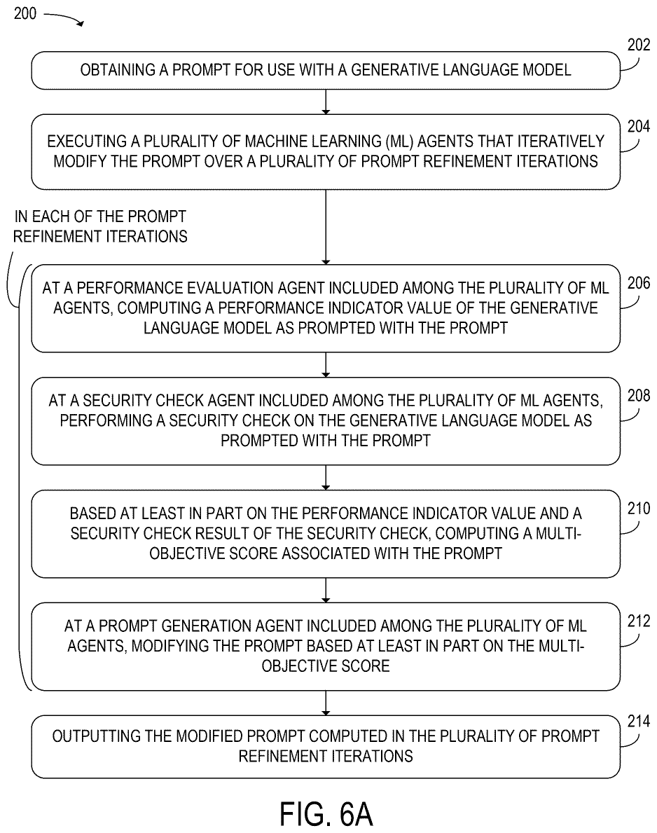

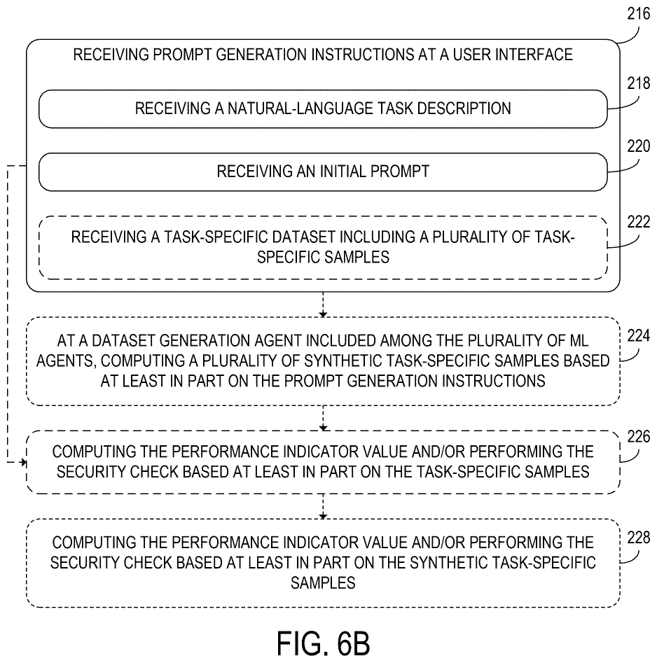

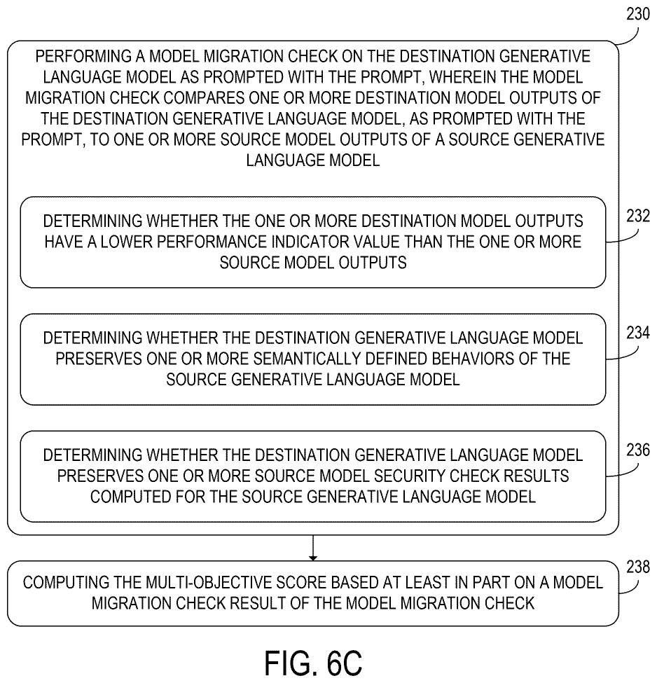

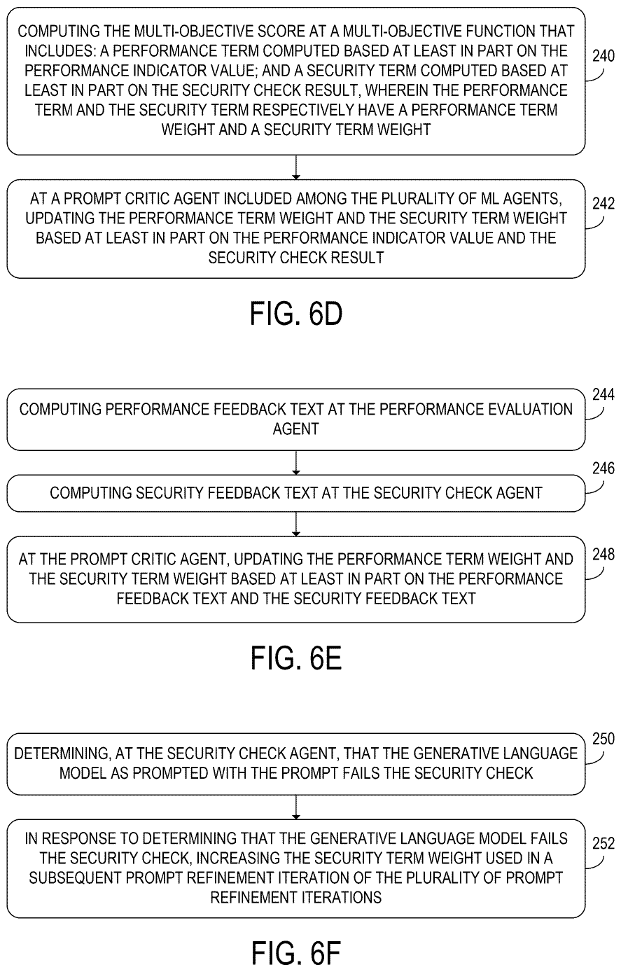

FIG. 6A shows a flowchart of a method 200 for use with a computing system to implement a multi-agent prompt refinement system. At step 202, the method 200 may include obtaining a prompt for use with a generative language model. The prompt may be a system prompt that is used to initialize interactions between a generative language model and a user of a chat interface. In some examples, the prompt is initialized at a prompt generation agent, which is an ML agent included in the multi-agent prompt refinement system.

At step 204, the method 200 further includes executing a plurality of ML agents that iteratively modify the prompt over a plurality of prompt refinement iterations. Each of the ML agents is configured to perform calls to one or more ML models, which may include one or more generative language models. Each of the ML agents may be further configured to utilize one or more agent tools, which include additional code that may be called by the ML agents to provide one or more additional input sources, output modalities, performance indicators, safety checks, and/or model migration checks. The set of agent tools available to an ML agent may be extensible. Each of the ML agents may additionally or alternatively have agent memory, agent planning, and/or a prompt fragment library. In addition, an ML agent may communicate with other ML agents.

Each of the prompt refinement iterations includes, at step 206, computing a performance indicator value of the generative language model as prompted with the prompt. The performance indicator value is computed at a performance evaluation agent included among the plurality of ML agents. For example, the performance indicator value may be computed using a performance indicator accessed by the performance evaluation agent as an agent tool.

At step 208, each of the prompt refinement iterations further includes performing a security check on the generative language model as prompted with the prompt. The security check may be performed at a security check agent included among the plurality of ML agents and may return a numerical security score. For example, the security check agent may test the generative language model for safety or security risks such as jailbreak susceptibility, adversarial injection susceptibility, confidential data leakage, hallucinations, deception, and/or other types of risks or vulnerabilities. The security check may be provided to the security check agent as an agent tool.

In each of the prompt refinement iterations, the prompt may be paired with a plurality of different sample input fragments that are also included in the context window of the generative language model. The generative language model may generate respective model outputs as completions of the context, and those outputs may be used as inputs to the performance evaluation agent and the security check agent. In some examples, the performance evaluation agent and/or the security check agent receives one or more further sources of input in addition to the generative language model outputs. For example, the performance evaluation agent may receive an inferencing latency measurement as an additional input. As another example, the security check agent may call one or more interpretability tools that are applied to the generative language model.

At step 210, in each of the prompt refinement iterations, the method 200 further includes computing a multi-objective score associated with the prompt based at least in part on the performance indicator value and a security check result of the security check. The multi-objective score therefore incorporates both performance-related and safety/security-related properties of the generative language model as prompted with the prompt.

At step 212, in each of the prompt refinement iterations, the method 200 further includes modifying the prompt based at least in part on the multi-objective score. This modification is performed at a prompt generation agent included among the plurality of ML agents. At least a portion of the prompt is recomputed at a generative language model that is called by the prompt generation agent. That generative language model receives the prompt and the multi-objective score as inputs.

At step 214, subsequently to performing the plurality of prompt refinement iterations, the method 200 further includes outputting the modified prompt computed in the plurality of prompt refinement iterations. The modified prompt may be output to a user interface such as a GUI or an audio interface. One or more multi-objective scores, performance indicator values, and/or security check results computed in the plurality of prompt refinement iterations may also be output to the user interface. Subsequently to outputting the modified prompt, that prompt may be further used as an inferencing input to the generative language model, for example, as a system prompt.

FIGS. 6B-6F show additional steps of the method 200 that may be performed in some examples. FIG. 6B shows example steps that may be performed when obtaining the prompt at step 202 and when computing the multi-objective score at step 210. At step 216, the method 200 may further include receiving prompt generation instructions at a user interface. Receiving the prompt generation instructions may include, at step 218, receiving a natural-language task description. Additionally or alternatively, at step 220, receiving the prompt generation instructions may include receiving an initial prompt. Other types of prompt generation instructions may also be received at the user interface in some examples. For example, the user may input a model selection that specifies a generative language model for which the prompt is computed. In examples in which model migration is performed, the model selection may indicate a source generative language model and a destination generative language model. The prompt generation instructions may also include a selection of a prompt style, which may indicate that the prompt is a CoT prompt, a ToT prompt, or a prompt that does not have either a CoT structure or a ToT structure.

In some examples, at step 222, receiving the prompt generation instructions may further include the prompt generation instructions include a task-specific dataset including a plurality of task-specific samples. In some examples, at step 224, the method 200 may further include computing a plurality of synthetic task-specific samples based at least in part on the prompt generation instructions. These synthetic task-specific samples may be computed at a dataset generation agent included among the plurality of ML agents.

During iterative prompt refinement, the task-specific samples and/or synthetic task-specific samples may be included in the context window of the generative language model along with the prompt. Thus, in examples in which step 222 is performed, the method 200 may further include, at step 226, computing the performance indicator value and/or performing the security check based at least in part on the task-specific samples. In examples in which step 224 is performed, the method 200 may further include, at step 228, computing the performance indicator value and/or performing the security check based at least in part on the synthetic task-specific samples. The task-specific samples and/or the synthetic task-specific samples may accordingly be used as validation data during iterative prompt refinement.

FIG. 6C shows steps of the method 200 that may be performed in examples in which the prompt generation instructions indicate a source generative language model and a destination generative language model. At step 230, the method 200 may further include performing a model migration check on the destination generative language model as prompted with the prompt. The model migration check compares one or more destination model outputs of the destination generative language model, as prompted with the prompt, to one or more source model outputs of a source generative language model. In some examples, the source generative language model may be prompted with the same prompt as the destination generative language model when performing the model migration check. In other examples, the source generative language model may instead be prompted with a prompt that was previously computed during iterative prompt refinement for the source generative language model.

In some examples, the model migration check may be a performance regression check. In such examples, performing the model migration check at step 230 may include, at step 232, determining whether the one or more destination model outputs have a lower performance indicator value than the one or more source model outputs. The performance indicator values of the one or more source model outputs may be compared to the performance indicator values of the one or more destination model outputs at each of the prompt refinement iterations. Alternatively, the prompt may be checked for performance regression at a lower frequency.

In some examples, the model migration check may be a behavior preservation check. In such examples, performing the model migration check at step 230 may include, at step 234, determining whether the destination generative language model preserves one or more semantically defined behaviors of the source generative language model. For example, the one or more semantically defined behaviors may be one or more stylistic features of the source model outputs. The prompt may, for example, be checked for behavior preservation using an embedding vector similarity metric or using an output alignment score computed at a generative language model.

In some examples, the model migration check may be a security preservation check. In such examples, performing the model migration check at step 230 may include, at step 236, determining whether the destination generative language model preserves one or more source model security check results computed for the source generative language model. In examples in which the security check results are numerical scores, performing the security preservation check may include determining whether the destination generative language model reaches a security score greater than or equal to that of the source generative language model. In examples in which the security check results each include one or more binary pass-fail indicators, performing the security preservation check may include determining whether the destination generative language model passes each of the security checks that the source generative language model passes.

At step 238, the method 200 may further include computing the multi-objective score based at least in part on a model migration check result of the model migration check. Accordingly, the model migration check result may be integrated into the multi-objective score.

FIG. 6D shows additional steps of the method 200 that may be performed in some examples. Step 240, as shown in FIG. 6D, may be performed to compute the multi-objective score at step 210. At step 240, the method 200 may further include computing the multi-objective score at a multi-objective function that includes a performance term and a security term, where the performance term is computed based at least in part on the performance indicator value and the security term is computed based at least in part on the security check result. The performance term and the security term may respectively have a performance term weight and a security term weight. In examples in which a model migration check is performed, the multi-objective function may further include a model migration term, which may have a model migration term weight.

At step 242, the method 200 may further include updating the performance term weight and the security term weight based at least in part on the performance indicator value and the security check result. This updating may be performed at a prompt critic agent included among the plurality of ML agents. The prompt critic agent may receive the prompt as an additional input. In examples in which the multi-objective function includes a model migration term, the prompt critic agent may also update the model migration term weight.

FIG. 6E shows additional steps of the method 200 that may be performed in examples in which the steps of FIG. 6D are performed. At step 244, the method 200 may further include computing performance feedback text at the performance evaluation agent. In addition, at step 246, the method 200 may further include computing security feedback text at the security check agent. The performance feedback text and the security feedback text may be computed at one or more generative language models and may provide additional details related to the performance check and the security check beyond the numerical values computed as the performance indicator value and the security check result.

At step 248, the method 200 may further include updating the performance term weight and the security term weight at the prompt critic agent based at least in part on the performance feedback text and the security feedback text. The prompt critic agent may also update the model migration term weight based at least in part on the performance feedback text and the security feedback text in examples in which the multi-objective score function includes a model migration term. The prompt critic agent may update the term weights at least in part by inputting the performance feedback text and the security feedback text into a generative language model. In some examples, the prompt critic agent may also normalize the term weights to sum to one.

FIG. 6F shows additional steps of method 200 that may be performed in examples in which the steps of FIG. 6D are performed. At step 250, performing the security check at step 208 may include determining, at the security check agent, that the generative language model as prompted with the prompt fails the security check. At step 252, in response to determining that the generative language model fails the security check, the method 200 may further include increasing the security term weight used in a subsequent prompt refinement iteration of the plurality of prompt refinement iterations. This increase in the security term weight may be computed at the prompt critic agent. In examples in which the steps of FIG. 6E are performed, the increase in the security term weight may also be computed based at least in part on the security feedback text.

Using the systems and methods discussed above, a prompt for use with a generative language model is programmatically generated in an iterative refinement loop that includes one or more security checks as well as one or more performance checks. This iterative refinement loop therefore integrates safety and security testing into programmatic prompt refinement rather than confining safety and security testing to a separate red-teaming phase of the prompt development process. In addition, the performance indicators and safety/security checks are provided in a modular, extensible manner that allows additional benchmarks and safety/security techniques to be added to the iterative refinement loop without major workflow restructuring. The checks performed on the prompt may accordingly be updated as new benchmarks and safety/security techniques become available or as characteristics of the generative language model change. For example, advanced safety risk checks may be added to the iterative refinement loop as generative language model scale increases.

The systems and methods discussed above also allow developers to incorporate model migration checks into programmatic prompt refinement. These model migration checks are performed to determine whether a destination generative language model maintains properties of a source generative language model related to performance, safety, security, and/or semantically defined behavior. Accordingly, multi-agent prompt refinement system may generate a prompt that allows a user to substitute the destination generative language model for the source generative language model without significantly disrupting existing workflows or introducing security vulnerabilities. The model migration check may also be used to maintain stylistic features of the outputs of the source model when the destination model is used instead.

The methods and processes described herein are tied to a computing system of one or more computing devices. In particular, such methods and processes can be implemented as a computer-application program or service, an application-programming interface (API), a library, and/or other computer-program product.

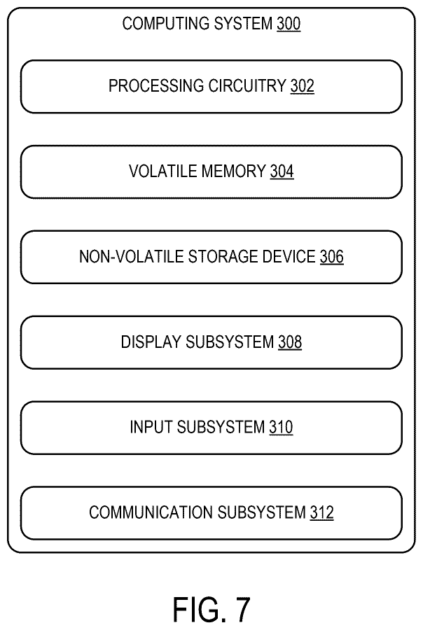

FIG. 7 schematically shows a non-limiting embodiment of a computing system 300 that can enact one or more of the methods and processes described above. Computing system 300 is shown in simplified form. Computing system 300 may instantiate the computing system 10 discussed above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to, at a multi-agent prompt refinement system, obtain a prompt for use with a generative language model. The one or more processing devices are further configured to execute a plurality of machine learning (ML) agents that iteratively modify the prompt over a plurality of prompt refinement iterations. Each of the prompt refinement iterations includes, at a performance evaluation agent included among the plurality of ML agents, computing a performance indicator value of the generative language model as prompted with the prompt. At a security check agent included among the plurality of ML agents, each of the prompt refinement iterations further includes performing a security check on the generative language model as prompted with the prompt. Each of the prompt refinement iterations further includes, based at least in part on the performance indicator value and a security check result of the security check, computing a multi-objective score associated with the prompt. At a prompt generation agent included among the plurality of ML agents, each of the prompt refinement iterations further includes modifying the prompt based at least in part on the multi-objective score. The one or more processing devices are further configured to output the modified prompt computed in the plurality of prompt refinement iterations. The above features may have the technical effect of incorporating safety and security checks into programmatic prompt refinement along with performance checks, thereby allowing the safety and security properties of the prompt to be tested and adjusted more efficiently.

According to this aspect, the one or more processing devices may be configured to obtain the prompt at least in part by receiving prompt generation instructions at a user interface. The prompt generation instructions may include a natural-language task description and/or an initial prompt. The above features may have the technical effect of initializing the prompt as specified by user input.

According to this aspect, the prompt generation instructions may include a task-specific dataset including a plurality of task-specific samples. The one or more processing devices may be further configured to compute the performance indicator value and/or perform the security check based at least in part on the task-specific samples. The above features may have the technical effect of, at the generative language model, performing the prompt refinement iterations on the prompt combined with a plurality of different sample input fragments.

According to this aspect, the one or more processing devices may be further configured to, at a dataset generation agent included among the plurality of ML agents, compute a plurality of synthetic task-specific samples based at least in part on the prompt generation instructions. The one or more processing devices may be further configured to compute the performance indicator value and/or perform the security check based at least in part on the synthetic task-specific samples. The above features may have the technical effect of computing synthetic task-specific samples that are used as sample input fragments along with the prompt during the plurality of prompt refinement iterations.

According to this aspect, the generative language model may be a destination generative language model. In each of the prompt refinement iterations, the one or more processing devices may be further configured to perform a model migration check on the destination generative language model as prompted with the prompt. The model migration check may compare one or more destination model outputs of the destination generative language model, as prompted with the prompt, to one or more source model outputs of a source generative language model. The one or more processing devices may be further configured to compute the multi-objective score based at least in part on a model migration check result of the model migration check. The above features may have the technical effect of determining, during the prompt refinement iterations, whether the outputs of the destination generative language model preserve specific properties of the outputs of the source generative language model.

According to this aspect, the model migration check may be a performance regression check in which the one or more processing devices are configured to determine whether the one or more destination model outputs have a lower performance indicator value than the one or more source model outputs. The above features may have the technical effect of determining whether the destination generative language model maintains the performance of the source generative language model.

According to this aspect, the model migration check may be a behavior preservation check in which the one or more processing devices are configured to determine whether the destination generative language model preserves one or more semantically defined behaviors of the source generative language model. The above features may have the technical effect of determining whether the destination generative language model maintains one or more stylistic features, specialized behaviors, or other semantically defined behaviors of the source generative language model.

According to this aspect, the model migration check may be a security preservation check in which the one or more processing devices are configured to determine whether the destination generative language model preserves one or more source model security check results computed for the source generative language model. The above features may have the technical effect of determining whether the destination generative language model maintains safety and security properties of the source generative language model when prompted with the prompt.

According to this aspect, the one or more processing devices may be configured to compute the multi-objective score at a multi-objective function that includes a performance term computed based at least in part on the performance indicator value and a security term computed based at least in part on the security check result. The performance term and the security term may respectively have a performance term weight and a security term weight. The above features may have the technical effect of modifying the prompt based at least in part on a weighted combination of performance properties and security properties.

According to this aspect, at a prompt critic agent included among the plurality of ML agents, the one or more processing devices may be further configured to update the performance term weight and the security term weight based at least in part on the performance indicator value and the security check result. The above features may have the technical effect of adjusting the relative weighting of the performance properties and security properties during iterative prompt refinement.

According to this aspect, the one or more processing devices may be further configured to compute performance feedback text at the performance evaluation agent and compute security feedback text at the security check agent. At the prompt critic agent, the one or more processing devices may be further configured to update the performance term weight and the security term weight based at least in part on the performance feedback text and the security feedback text. The above features may have the technical effect of providing additional details related to the performance and security checks as feedback to the prompt critic agent.

According to this aspect, the one or more processing devices may be further configured to determine, at the security check agent, that the generative language model as prompted with the prompt fails the security check. At the prompt critic agent, in response to determining that the generative language model fails the security check, the one or more processing devices may be further configured to increase the security term weight used in a subsequent prompt refinement iteration of the plurality of prompt refinement iterations. The above features may have the technical effect of placing increased emphasis on the security term in the multi-objective function in response to detecting a security check failure.

According to another aspect of the present disclosure, a method for use with a computing system is provided. The method includes, at a multi-agent prompt refinement system, obtaining a prompt for use with a generative language model. The method further includes executing a plurality of machine learning (ML) agents that iteratively modify the prompt over a plurality of prompt refinement iterations. Each of the prompt refinement iterations includes, at a performance evaluation agent included among the plurality of ML agents, computing a performance indicator value of the generative language model as prompted with the prompt. At a security check agent included among the plurality of ML agents, each of the prompt refinement iterations further includes performing a security check on the generative language model as prompted with the prompt. Based at least in part on the performance indicator value and a security check result of the security check, each of the prompt refinement iterations further includes computing a multi-objective score associated with the prompt. At a prompt generation agent included among the plurality of ML agents, each of the prompt refinement iterations further includes modifying the prompt based at least in part on the multi-objective score. The method further includes outputting the modified prompt computed in the plurality of prompt refinement iterations. The above features may have the technical effect of incorporating safety and security checks into programmatic prompt refinement along with performance checks, thereby allowing the safety and security properties of the prompt to be tested and adjusted more efficiently.

According to this aspect, obtaining the prompt may include receiving prompt generation instructions at a user interface. The prompt generation instructions may include a natural-language task description and/or an initial prompt. The above features may have the technical effect of initializing the prompt as specified by user input.

According to this aspect, the prompt generation instructions may include a task-specific dataset including a plurality of task-specific samples. The method may further include computing the performance indicator value and/or performing the security check based at least in part on the task-specific samples. The above features may have the technical effect of, at the generative language model, performing the prompt refinement iterations on the prompt combined with a plurality of different sample input fragments.

According to this aspect, the generative language model may be a destination generative language model. In each of the prompt refinement iterations, the method may further include performing a model migration check on the destination generative language model as prompted with the prompt. The model migration check may compare one or more destination model outputs of the destination generative language model, as prompted with the prompt, to one or more source model outputs of a source generative language model. The method may further include computing the multi-objective score based at least in part on a model migration check result of the model migration check. The above features may have the technical effect of determining, during the prompt refinement iterations, whether the outputs of the destination generative language model preserve specific properties of the outputs of the source generative language model.

According to this aspect, the model migration check may be a performance regression check that includes determining whether the one or more destination model outputs have a lower performance indicator value than the one or more source model outputs, or a security preservation check that includes determining whether the destination generative language model preserves one or more source model security check results computed for the source generative language model. The above features may have the technical effect of determining whether the destination generative language model maintains the performance and/or security properties of the source generative language model.

According to this aspect, the method may further include computing the multi-objective score at a multi-objective function that includes a performance term computed based at least in part on the performance indicator value and a security term computed based at least in part on the security check result. The performance term and the security term may respectively have a performance term weight and a security term weight. The above features may have the technical effect of modifying the prompt based at least in part on a weighted combination of performance properties and security properties.

According to this aspect, the method may further include, at a prompt critic agent included among the plurality of ML agents, updating the performance term weight and the security term weight based at least in part on the performance indicator value and the security check result. The above features may have the technical effect of adjusting the relative weighting of the performance properties and security properties during iterative prompt refinement.

According to another aspect of the present disclosure, a computing system is provided, including one or more processing devices configured to obtain a prompt for use with a generative language model. The one or more processing devices are further configured to iteratively modify the prompt over a plurality of prompt refinement iterations. Each of the prompt refinement iterations includes computing a performance indicator value of the generative language model as prompted with the prompt. Each of the prompt refinement iterations further includes performing a security check on the generative language model as prompted with the prompt. At a multi-objective function, each of the prompt refinement iterations further includes computing a multi-objective score associated with the prompt based at least in part on the performance indicator value and a security check result of the security check. The multi-objective function includes a performance term computed based at least in part on the performance indicator value and a security term computed based at least in part on the security check result. The performance term and the security term respectively have a performance term weight and a security term weight. Each of the prompt refinement iterations further includes computing performance feedback text and security feedback text associated with the prompt. Each of the prompt refinement iterations further includes updating the performance term weight and the security term weight based at least in part on the performance feedback text and the security feedback text. Each of the prompt refinement iterations further includes modifying the prompt based at least in part on the multi-objective score. The one or more processing devices are further configured to output the modified prompt computed in the plurality of prompt refinement iterations. The above features may have the technical effect of incorporating safety and security checks into programmatic prompt refinement along with performance checks, thereby allowing the safety and security properties of the prompt to be tested and adjusted more efficiently.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to, at a multi-agent prompt refinement system:
obtain a prompt for use with a generative language model;
execute a plurality of machine learning (ML) agents that iteratively modify the prompt over a plurality of prompt refinement iterations, wherein each of the prompt refinement iterations includes:
at a performance evaluation agent included among the plurality of ML agents, computing a performance indicator value of the generative language model as prompted with the prompt;
at a security check agent included among the plurality of ML agents, performing a security check on the generative language model as prompted with the prompt;
based at least in part on the performance indicator value and a security check result of the security check, computing a multi-objective score associated with the prompt; and
at a prompt generation agent included among the plurality of ML agents, modifying the prompt based at least in part on the multi-objective score; and
output the modified prompt computed in the plurality of prompt refinement iterations.

2. The computing system of claim 1, wherein:
the one or more processing devices are configured to obtain the prompt at least in part by receiving prompt generation instructions at a user interface; and
the prompt generation instructions include a natural-language task description and/or an initial prompt.

3. The computing system of claim 2, wherein:
the prompt generation instructions include a task-specific dataset including a plurality of task-specific samples; and
the one or more processing devices are further configured to compute the performance indicator value and/or perform the security check based at least in part on the task-specific samples.

4. The computing system of claim 2, wherein the one or more processing devices are further configured to:
at a dataset generation agent included among the plurality of ML agents, compute a plurality of synthetic task-specific samples based at least in part on the prompt generation instructions; and
compute the performance indicator value and/or perform the security check based at least in part on the synthetic task-specific samples.

5. The computing system of claim 1, wherein:
the generative language model is a destination generative language model;
in each of the prompt refinement iterations, the one or more processing devices are further configured to:
perform a model migration check on the destination generative language model as prompted with the prompt, wherein the model migration check compares one or more destination model outputs of the destination generative language model, as prompted with the prompt, to one or more source model outputs of a source generative language model; and
compute the multi-objective score based at least in part on a model migration check result of the model migration check.

6. The computing system of claim 5, wherein the model migration check is a performance regression check in which the one or more processing devices are configured to determine whether the one or more destination model outputs have a lower performance indicator value than the one or more source model outputs.

7. The computing system of claim 5, wherein the model migration check is a behavior preservation check in which the one or more processing devices are configured to determine whether the destination generative language model preserves one or more semantically defined behaviors of the source generative language model.

8. The computing system of claim 5, wherein the model migration check is a security preservation check in which the one or more processing devices are configured to determine whether the destination generative language model preserves one or more source model security check results computed for the source generative language model.

9. The computing system of claim 1, wherein:
the one or more processing devices are configured to compute the multi-objective score at a multi-objective function that includes:
a performance term computed based at least in part on the performance indicator value; and
a security term computed based at least in part on the security check result; and
the performance term and the security term respectively have a performance term weight and a security term weight.

10. The computing system of claim 9, wherein, at a prompt critic agent included among the plurality of ML agents, the one or more processing devices are further configured to update the performance term weight and the security term weight based at least in part on the performance indicator value and the security check result.

11. The computing system of claim 10, wherein the one or more processing devices are further configured to:
compute performance feedback text at the performance evaluation agent;
compute security feedback text at the security check agent; and
at the prompt critic agent, update the performance term weight and the security term weight based at least in part on the performance feedback text and the security feedback text.

12. The computing system of claim 10, wherein the one or more processing devices are further configured to:
determine, at the security check agent, that the generative language model as prompted with the prompt fails the security check; and
at the prompt critic agent, in response to determining that the generative language model fails the security check, increase the security term weight used in a subsequent prompt refinement iteration of the plurality of prompt refinement iterations.

13. A method for use with a computing system, the method comprising, at a multi-agent prompt refinement system:
obtaining a prompt for use with a generative language model;
executing a plurality of machine learning (ML) agents that iteratively modify the prompt over a plurality of prompt refinement iterations, wherein each of the prompt refinement iterations includes:
at a performance evaluation agent included among the plurality of ML agents, computing a performance indicator value of the generative language model as prompted with the prompt;
at a security check agent included among the plurality of ML agents, performing a security check on the generative language model as prompted with the prompt;
based at least in part on the performance indicator value and a security check result of the security check, computing a multi-objective score associated with the prompt; and
at a prompt generation agent included among the plurality of ML agents, modifying the prompt based at least in part on the multi-objective score; and
outputting the modified prompt computed in the plurality of prompt refinement iterations.

14. The method of claim 13, wherein:
obtaining the prompt includes receiving prompt generation instructions at a user interface; and
the prompt generation instructions include a natural-language task description and/or an initial prompt.

15. The method of claim 14, wherein:
the prompt generation instructions include a task-specific dataset including a plurality of task-specific samples; and
the method further comprises computing the performance indicator value and/or performing the security check based at least in part on the task-specific samples.

16. The method of claim 13, wherein:
the generative language model is a destination generative language model;
in each of the prompt refinement iterations, the method further comprises:
performing a model migration check on the destination generative language model as prompted with the prompt, wherein the model migration check compares one or more destination model outputs of the destination generative language model, as prompted with the prompt, to one or more source model outputs of a source generative language model; and
computing the multi-objective score based at least in part on a model migration check result of the model migration check.

17. The method of claim 16, wherein the model migration check is:
a performance regression check that includes determining whether the one or more destination model outputs have a lower performance indicator value than the one or more source model outputs; or
a security preservation check that includes determining whether the destination generative language model preserves one or more source model security check results computed for the source generative language model.

18. The method of claim 13, further comprising computing the multi-objective score at a multi-objective function that includes:
a performance term computed based at least in part on the performance indicator value; and
a security term computed based at least in part on the security check result,
wherein the performance term and the security term respectively have a performance term weight and a security term weight.

19. The method of claim 18, further comprising, at a prompt critic agent included among the plurality of ML agents, updating the performance term weight and the security term weight based at least in part on the performance indicator value and the security check result.

20. A computing system comprising:
one or more processing devices configured to:
obtain a prompt for use with a generative language model;
iteratively modify the prompt over a plurality of prompt refinement iterations, wherein each of the prompt refinement iterations includes:
computing a performance indicator value of the generative language model as prompted with the prompt;
performing a security check on the generative language model as prompted with the prompt;
at a multi-objective function, computing a multi-objective score associated with the prompt based at least in part on the performance indicator value and a security check result of the security check, wherein the multi-objective function includes:
a performance term computed based at least in part on the performance indicator value; and
a security term computed based at least in part on the security check result, wherein the performance term and the security term respectively have a performance term weight and a security term weight;
computing performance feedback text and security feedback text associated with the prompt;
updating the performance term weight and the security term weight based at least in part on the performance feedback text and the security feedback text;
modifying the prompt based at least in part on the multi-objective score; and
output the modified prompt computed in the plurality of prompt refinement iterations.
